(19) United States
(12) Patent Application Publication
(10) Pub. No.: US 2006/0076707 A1
(43) Pub. Date: Apr. 13, 2006

(54) Cellulose acylate film and production method thereof

(75) Inventor: Masaru Sugiura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/239,365

(22) Filed: Sep. 30, 2005

(30) Foreign Application Priority Data
Sep. 30, 2004 (JP) 2004-287228

(51) Int. Cl. B29C 39/14; B29C 39/28; C13F 3/00; B29D 7/00

(52) U.S. Cl. 264/234; 264/217; 127/29

(57) ABSTRACT

A peeling force controller is added to a dope to be cast on a support. The peeling force controller is polycarboxylic derivatives, in which a content of said polycarboxylic acid is at most 50 wt. %. During peeling the cast dope as a film from the support, the peeling force is at most 60×9.8 (mN) per 1 cm in width of the film. Thus the film is peeled stably and speedy from the support, and the generation of metal salts of the peeling force controller is reduced such that the pollution of a film production apparatus is prevented. Accordingly, the film excellent in optical property is continuously produced at high speed.

### BACKGROUND OF THE INVENTION

1. Field of the Invention

The present invention relates to a cellulose acylate film and a production method thereof, and especially to a cellulose acylate film as optical film and a method of producing the cellulose acylate film by casting a solution.

2. Description Related to the Prior Art

A cellulose acylate film is often used for a polarizing filter, in a liquid crystal display and so on, because of several features, such as optical characteristics, adequate moisture permeability, optical isotropy, mechanical properties and the like. The cellulose acylate film is usually manufactured by a solution casting method. As representative film production method, there are a melt-extrusion method and a solution casting method. The film produced by the solution casting is more excellent in thickness uniformity and smoothness than the film produced by the melt extrusion. Therefore, the former film is superior to the latter one in the optical properties.

In the solution casting method, a liquid called a dope in which cellulose acylate, additives and the like are dissolved to or dispersed in a solvent is cast from a casting die onto a running support to form a casting film, which is peeled as a film. Thereafter, the film is dried under predetermined conditions, and then wound up continuously.

Recently, in order to response to an expansion of demand for the liquid crystal display, it is extremely necessary to increase the productivity of the cellulose acylate film, and therefore a casting speed of the dope should be increased. In accordance with the increase of the casting speed, it is necessary to increase a peeling speed for peeling the casting film (or the dope on the support) from the support. However, if the peelability is low, some defects occur on a film surface.

The peelability of the casting film from the support depends on sectional area, mechanical strength and the like of the casting film, but on an adhesive force of the casting film to the support the most. The adhesive force occurs on the basis of hydrogen bonds between cellulose acylate and metal of a support surface and ionic bonds between the casting film and the support through calcium ions which are originally contained in cellulose acylate as a raw material of the casting film. Especially, the force of the ionic bonds is larger than the hydrogen bonds. Therefore, in Japanese Patent Laid-Open Publication No. 10-316701, in order to decrease the force of the ionic bonds, an acid is added as a release agent to the dope.

However, according to the method of the above publication, although the adhesive force to the support is reduced to increase the peelability from the support, the action occurs between acid and metal ions contained in cellulose acylate as raw material of the cellulose acylate film, so as to produce metal salts, which pollutes not only a surface of the support, but also all of a film production apparatus.

### SUMMARY OF THE INVENTION

An object of the present invention is to provide a film production method in which it is reduced that a release agent causes to generate foreign materials, such that the continuous running period of the film production apparatus may become longer.

Another object of the present invention is to provide a film production method in which a peelability of the casting film from the support, especially, the high speed peelability and the stable peelability, is increased, such that a production efficiency of the cellulose acylate film may become higher.

Still another object of the present invention is to provide a cellulose acylate film for optical use, in which defects of film surface does not occur.

In order to achieve the object and the other object, in a method of producing a cellulose acylate film, a solution containing cellulose acylate, a solvent and polycarboxylic acid derivative is cast onto a running support, and the cast solution is peeled as a film for drying. When the polycarboxylic acid derivative contain polycarboxylic acid derivative, weight of the polycarboxylic acid is at most that of the polycarboxylic acid derivative.

Preferably, the carboxylic acid derivative are such a peeling force controller that the peeling force may be at most 60×9.8 (mN) per 1 cm in width of the film during peling teh film from the support.

Preferably, the polycarboxylic acid derivative are polycarboxylic acid esters. Particularly preferably, following conditions are satisfied,
ya≦Y/2; and
0.5≦(Y−ya)/(X+Y)≦1.0,
wherein X is weight (unit, g) of the polycarboxylic acid, Y is weight (unit, g) of the polycarboxylic acid esters, and ya is weight (unit, g) of entire esterified compounds contained in the polycarboxylic acid esters. Further, particularly preferably, the polycarboxylic acid desters are citric acid alkyl esters. It is especially preferable to satisfy a following condition,
0.25≦y2/y1≦4,
wherein y1 is weight (unit; g) of monoesters and y2 is weight (unit; g) of diesters. Furthermore, it is especially preferable that the citric acid alkylesters are at least one of citric methylesters and citric ethylesters.

A cellulose acylate film of the present invention contains cellulose acylate and polycarboxylic acid derivative, in which a weight of polycarboxylic acid is at most that of polycarboxylic acid derivative. Preferably, the polycarboxylic acid derivative are polycarboxylic acid esters. It is particularly preferable to satisfy conditions:
ya≦Y/2; and
0.5≦(Y−ya)/(X+Y)≦1.0,
wherein X is weight (unit, g) of the polycarboxylic acid, Y is weight (unit, g) of the polycarboxylic acid esters, and ya is weight (unit, g) of entire esterified compounds contained in the polycarboxylic acid esters. Particularly preferably, the polycarboxylic acid desters are citric acid alkyl esters. It is especially preferable to satisfy a following condition,
0.25≦y2/y1≦4,
wherein y1 is weight (unit; g) of monoesters and y2 is weight (unit; g) of diesters. Furthermore, it is especially preferable that the citric acid alkylesters are at least one of citric methylesters and citric ethylesters.

According to the present invention, the peelability of the casting film from the support is increased, and the generation of the salts of metals contained in cellulose acylate is reduced. Thus the cellulose acylate film can be produced without polluting a film production apparatus. Thus the efficiency of the film production is increased, a number of maintenance such as apparatus cleaning and the like becomes lower, and the running period becomes longer.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a first embodiment of a dope production apparatus to which the present invention is applied;

FIG. 2 is a schematic diagram of a solution casting apparatus to which the present invention is applied;

FIG. 3 is an explanatory view illustrating a situation for casting three sorts of dopes from a casting die to a support.

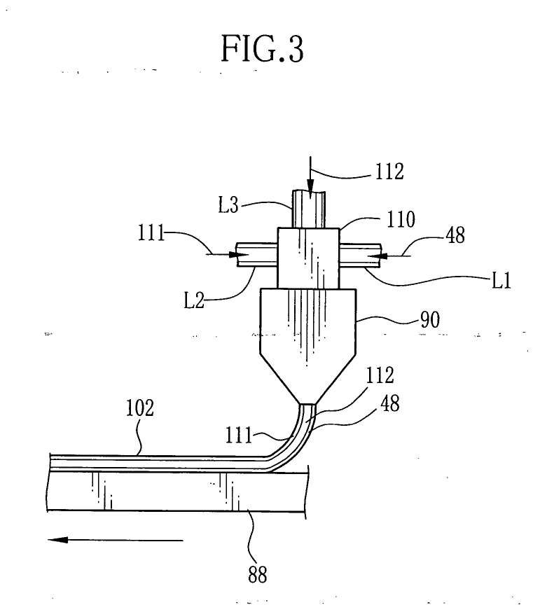

### PREFERRED EMBODIMENTS OF THE INVENTION

In followings, embodiments of the present invention will be explained. However, the present invention is not restricted in the embodiments.

As cellulose acylate of this embodiment, triacetyl cellulose (TAC) is especially preferable. TAC may be produced from cotton linter or cotton pulp, or a mixture of materials respectively obtained from cotton linter and cotton pulp, and preferable TAC is produced from cotton linter. It is preferable in cellulose acylate that the degree of substitution of acyl groups for hydrogen atoms on hydroxyl groups of cellulose preferably satisfies all of following formulae (I)-(III). In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 wt. % of TAC is particles having diameters from 0.1 mm to 4 mm.
2.5≦A+B≦3.0 (I)
0≦A≦3.0 (II)
0≦B≦2.9 (III)

A glucose unit constructing cellulose with β-1,4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100%, the degree of acylation is 1. Therefore, if all of the three hydroxyl groups is esterified at 100%, the degree of acylation is 3.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6 th position). The total of the degree of acylation, DS2+DS3+DS6, is preferably 2.00 to 3.00, particylarly 2.22 to 2.90, and especially 2.40 to 2.88. Further, DS6/(DS2+DS3+DS6) is preferably at least 0.32, particularly at least 0.322, and especially 0.324 to 0.340.

In the present invention, the number and sort of the acyl groups in cellulose acylate may be only one or at least two. If there are at least two sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.2 to 2.86, especially 2.40 to 2.80. Further, DSB is preferably at least 1.50, and especially at least 1.7. According to DSB, the percentage of the substitution on the 6^{th} position to that on the 2^{nd}, 3^{rd} and 6^{th} positions is at least 28%. However, the percentage is preferably at least 30%, particularly at least 31%, and especially at least 32%. Further, DSA+DSB of the 6^{th} position of the cellulose acylate is preferably at least 0.75, particularly at least 0.80, and especially at least 0.85. When these sorts of cellulose acylate are used, a solution (or dope) having preferable solubility can be produced, and especially, the solution having preferable solubility to the non-chlorine type organic solvent can be produced. Further, when the above cellulose acylate is used, the produced solution has low viscosity and good filterability.

In cellulose acylate, the acyl group having at least 2 carbon atoms may be aliphatic group or aryl group. Such cellulose acylate is, for example, alkylcarbonyl ester and alkenylcarbonyl ester of cellulose. Further, there are aromatic carbonyl ester, aromatic alkyl carbonyl ester, or the like, and these compounds may have substituents. As preferable examples of the compounds, there are propionyl group, butanoyl group, pentanoyl group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinamoyl group and the like, and the especially preferable groups are propionyl group and butanoyl group.

Further, as solvents for preparing the dope, there are aromatic hydrocarbons (for example, benzene, toluene and the like), hydrocarbon halides (for example, dichloromethane, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like. Note that the dope is a polymer solution or dispersion in which a polymer and the like is dissolved to or dispersed in the solvent.

The solvents are preferably hydrocarbon halides having 1 to 7 carbon atoms, and especially dichloromethane. Then in view of the dissolubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 mass % to 25 mass %, and particularly in the range of 5 mass % to 20 mass %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 esters are preferable, and a mixture thereof can be used. These ethers, ketones and esters may have the ring structure. Further, the compounds having at least two of functional groups (namely, —O—, —CO— and —COO—) in ethers, ketones and esters can be used for the solvent. Further, the solvent may have other functional groups, such as alcoholic hydroxyl groups, in the chemical structure.

In the present invention, several sorts of additive compounds are added to the dope, adequately. For example, in this embodiment, the particles as matting agent are added to the dope, in order to prevent the adhesion of the film surfaces in a film roll.

In the present invention, in order to increase the peelability of the casting film from the support, a release controlling agent (hereinafter, release agent) is added to the dope. As release agent, polycarboxylic acid derivative in which the content of the polycatboxylic acid is at most 50 wt. % are used. Note that the content will be explained later.

Herein, a mechanism of adhesion of the casting film to the support and action of the above release agent will be explained in following. In order to obtain cellulose acylate, the acylation of cellulose is performed under control of acid catalyst, such as sulfuric acid and the like, and there after, the neutralization is performed with base. The representative base to be used for the neutralization is calcium hydroxide. If calcium hydroxide and the like are used as the base, metals, such as calcium and the like, remain in the obtained cellulose acylate. An oxide layer is probably formed on a surface of the metallic support, and therefore, if calcium remains in cellulose acylate, the adhesive force (or adhesiveness) of the casting film to the metal coating must become larger in the electric interaction than in the case that calcium doesn't remain in cellulose acylate. It is the reason for increase of the adhesive force (or peeling force).

In the case that polycarboxylic acid or derivative thereof are added as the release agent to a cellulose acylate solution, calcium and the like are removed from cellulose acylate, and contained in polycarboxylic acid and derivative thereof in several conditions, such as with chemical bonds and the like. For example, calcium in cellulose acylate is oxidized by —COOH of polycarboxylic acid or —COOH as residue of polycarboxylic acid derivative. Thus the electric affinity between the substrate and cellulose acylate in the casting film becomes weaker, and the peeling force can be made lower. Note that polycarboxylic acid derivative may be added to the prepared cellulose acylate solution, with cellulose acylate into the solvent, and before cellulose acylate to the solvent.

In polycarboxylic acid derivative as preferable release agent, there are polycarboxylic acid esters, halogenated compounds of polycarboxylic acid, polycarboxylic acid amide, anhydrides of polycarboxylic acid, salts, and the like. However, polycarboxylic acid derivative in the market usually contain polycarboxylic acid. The reason is that polycarboxylic acid derivative is produced from polycarboxylic acid as raw materials by derivativization and the reaction for producing the derivative is the reversible reaction. Therefore, polycarboxylic acid usually coexist with polycarboxylic acid derivative, depending on the objected sorts of the derivative. For example, if polycarboxylic acid ester is obtained by the esterification of polycarboxylic acid with alcohols under catalyst control, the esterification reaction is the reversible reaction, and therefore, it is hard to produce pure (100%) polycarboxylic acid derivative.

Polycarboxylic acid effectively decreases the adhesive force between the casting film and the support, but polluted the film production apparatus. The reason is that polycarboxylic acid make the chemical reaction to calcium in cellulose acylate solution as described above, such that the calcium salts (—COOCa) may be generated as insoluble precipitates. This phenomenum occurs easily if the content of polycarboxylic acid in the polymer solution is at least the predetermined value.

Otherwise, even though polycarboxylic acid derivative having —COOH as residue, the solubility to the organic solvent is kept by the derivatized group and therefore no precipitates generate. Further, in such derivative, the functions of increasing the peelability are the same as in the case of polycarboxylic acid.

The inventor found in the search and consideration that the undissolvable salt precipitate if the ratio of polycarboxylic acid to polycarboxylic acid derivative is larger than a predetermined value. Therefore, as described above, polycarboxylic acid derivative in which the content of polycarboxylic acid is at most 50 wt. % are used in the present invention. It means that if the weight of polycarboxylic acid is described as X and that of polycarboxylic acid derivative is as Y, a condition of X≦Y is satisfied. Thus, compared with the case of using as the release agent a mixture in which the weight of the polycarboxylic acid is larger than that of polycarboxylic acid derivative, the present invention has merits that the peelability becomes higher, the generation of the metal salts is made much lower and the pollution of the film production apparatus is reduced.

It is especially preferable to use polycarboxyl acid derivative containing no polycarboxylic acid. However, it is actually impossible. So, in the present invention, since the polycarboxylic acid have also functions to increase the peelability, the weight ratio of the polycarboxylic acid to polycarboxylic acid derivative are controlled so as to satisfy the above condition. Thus the peelability becomes larger and the generation of the metal salts is reduced. Therefore, in the present invention, the peeling can be made at high speed, and the film production can be made at high speed. Further, a number of the equipment maintenance for the cleaning and the like becomes smaller, and the running period can be made longer.

Preferably, the value [X/(X+Y)] is at most 0.1, such that the quantity of the generated metal salt can be smaller. The value [X/(X+Y)] is particularly preferably at most 0.05, and especially at most 0.025, and most especially at most 0.01.

The adding amount of the release agent to the dope is controlled depending on the peeling force. The peeling force is the same as the adhesive force of the film to the support. Further, in the present invention, the release agent is preferably added, such that the peeling force applied to the peeled film per 1 cm width may be at most. 60×9.8 (mN). Note that the method of measuring the peeling force is described later.

The preferable polycarboxylic acid derivative are polycarboxylic acid esters, in whose hydrolysis alcohols are produced. In this case, the damage of the film capability by the production of the hydrolysis can be made lower than other derivatives. Therefore, in this embodiment, the polycarboxylic acid esters are used as polycarboxylic acid derivative, and the following explanation is made for an example in which the polycarboxylic acid esters are used.

In polycarboxylic acid esters, the entirely esterified compounds (in which all carboxylic groups are esterified) have no hydroxy groups. In this case, the intermolecular force is too low, and therefore the volatilization characteristic from the casting film and the film is higher than the partially esterified compounds in which parts of the carboxyl groups are not esterified to remain. If the volatilization characteristic is high, the production process is polluted under some conditions, which causes the running period to be shorter and the defects of the film surface. Further, the entirely esterified compounds don't attribute the increase of the peelability so much as the partially esterified compounds. Therefore, in polycarboxylic acid esters, it is preferable that the content of the ester compounds whose averaged degree of esterification is nearly 100% is lower, namely that the weight ratio of the partially esterified compounds is larger and the weight ratio of the entirely esterified compounds is smaller. Thus the pollution of the film production equipment is prevented more effectively.

When the weight of the entirely esterified compounds is described as ya(g), conditions ya≦Y and 0.5≦(Y−ya)/(X+Y)≦1.0 are preferably satisfied. When ya=Y, the function for improving the peelability depends on the efficiency of the polycarboxylic acid, and the generation of metal salt of cellulose acylate is controlled under the existence of the entire ester. Further, when ya<Y, the partially esterified compounds attribute for increase the peelability and the reduction of the metal salt generation. Further, if the value (Y−ya)/(X+ya) is less than 0.5, the increase of peelability doesn't become enough, depending on peeling speed, materials of the support, and the like. Further, the value is larger than 1.0, calcium salts of the carboxylic acid are sometimes generated. In order to increase the peelability and reduce the generation of the calcium salts of carboxylic acid, the value (Y−ya)/(X+ya) is preferably from 0.8 to 1.0, particularly from 0.95 to 1.0, and especially from 0.97 to 1.0.

In this embodiment, citric acid ester is used as polycarboxylic acid ester. Citric acid ester is excellent in the increase of peelability and the reduction of metal salt generation. Further, as it is distributed widely, it is easily obtained. And this compound is excellent polycarboxylic acid ester in easiness of treatment.

In citric acid esters, if the weight of monoester is described as y1 (unit; g) and that of diester is as y2 (unit; g), this embodiment satisfies a condition 0.25≦y2/y1≦4. Thus the increase of the peelability and the reduction of the generation of calcium carboxylates are effectively made. If the value y2/y1 is smaller than 0.25, calcium salts of carboxylic acid is sometimes precipitated, and if the value is larger than 4, the peelability may not increase enough under such conditions as the peeling speed, the material of the support, and the like.

Alkyl ester of citric acid ester is preferably at least one of citric acid methylester and citric acid ethylester. If a number of carbon atoms in alkyl chain of alkyl ester is one or two, the dissolubility of citric acid ester to the solvent is larger than if a number of carbon atoms is at least three.

Note that the detailed explanation of cellulose acylate is made from [0140] to [0195] in Japanese Patent Laid-Open Publication No.2004-264464, and the description of this publication can be applied to the present invention. Note that the detailed explanation of the solvents and the additives (such as plasticizers, deterioration inhibitors, UV-absorptive agents, optical anisotropy controllers, dynes, matting agent, release agent, retardation controller and the like) is made from [0196] to [0516] in Japanese Patent Laid-Open Publication No.2004-264464.

The film produced from the cellulose acylate dope of the present invention can be used for a polarizing filter, as a member of a liquid crystal display, and so on. However, in view of inhibiting the deterioration under the circumstances in which the polarizing filter, the liquid crystal display or the like is used, the UV-absorptive agents are preferably added to the dope. The preferable UV-absorptive agent is excellent in absorption power of the UV-ray of at most 370 nm, and furthermore hardly absorbs the visible ray of at least 400 nm in view of the suitable displaying properties of the liquid crystal display. As concrete examples of the UV-absorbing agent to be used in the present invention, there are, for example, oxybenzophenone type compounds, benzotriazol type compounds, salitilic acid ester type compounds, benzophenone type compounds, cianoacrylate type compounds, nickel complex salt type compound and the like.

[Dope Production Method]

A production apparatus and a production method of the cellulose acylate dope of the present invention will be described below. Note that the following embodiments are examples of the present invention, and the present invention is not restricted in the embodiments.

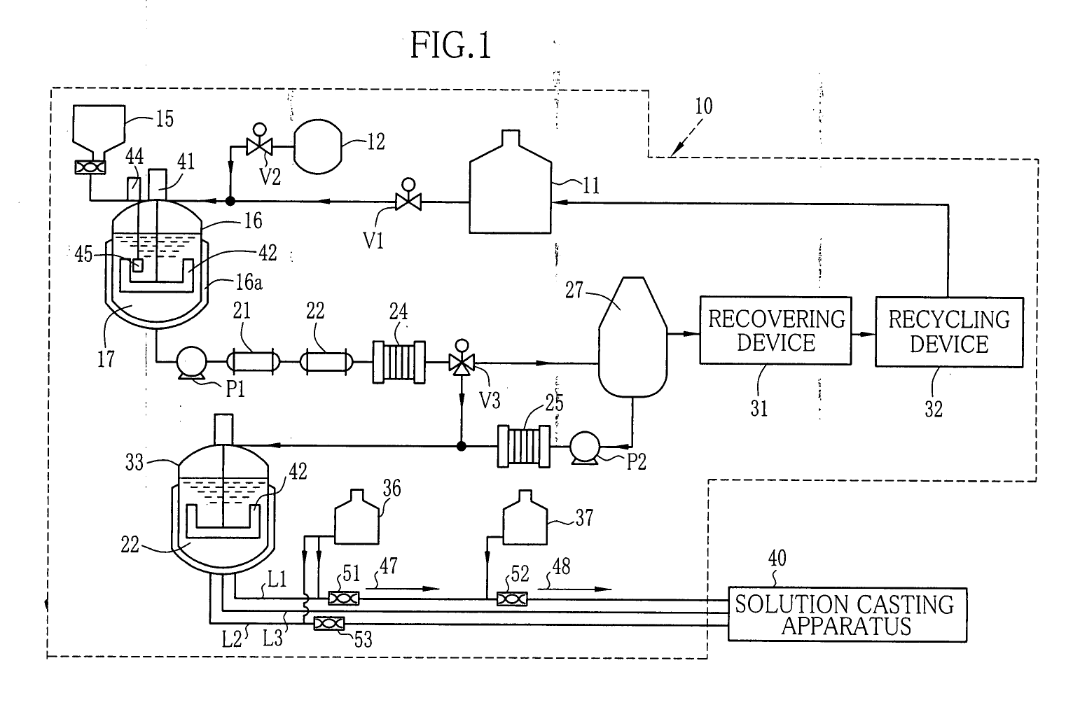

As shown in FIG. 1, a dope production apparatus 10 includes a first tank 11 for storing a solvent therein, a second tank 12 for storing predetermined additives, a hopper 15 for supplying TAC, and a third tank 16 for mixing the solvent, TAC and the predetermined additives. Further, the dope production apparatus 10 is provided with a heating device 21, a temperature controlling device 23, first and second filtration device 24,25, and a flushing device 27. The heating device 21 heats a mixture 17 which is obtained by stirring the mixture in the third tank 16. Then the temperature controlling device 23 controls a temperature of the heated mixture 17 such that a polymer solution 22 may be obtained from the mixture 17. The flushing device 27 controls a concentration of the polymer solution 22.

Further, the dope production apparatus 10 includes a recovering device 31 for recovering the solvent, a recirculating device 32 for recycling the recovered solvent, and a fourth tank 33 for storing the polymer solution 22. The dope production apparatus 10 further has fifth and sixth tanks 36,37 which are connected inline to a first feed line L1 among three feed lines between the fourth tank 33 and a solution casting apparatus 40. Furthermore, the fifth tank 36 is also connected inline to a second feed line L2. In the fifth tank 36, particles as a matting agent are accumulated, and the particles of this embodiment is silicon dioxide particles. Further, in the sixth tank 37, an citric acid ethylester as release agent is accumulated. The particles and the citric acid ethylester of the fifth and sixth tanks 36,37 are sometimes accumulated in the original situation (namely, particles or original citric acid ethylester) without addition of the solvent, respectively, and sometimes accumulated in a situation of a solution or a dispersion in that they are dissolved to or dispersed in a predetermined solvent.

Note, the third tank 16 has a jacket 16a covering over an outer surface, a first stirrer 42 rotating in accordance with the drive of a motor 41, and a second stirrer 45 rotating in accordance with the drive of a motor 44. The jacket 16a forms a space on the outer surface of the third tank 16, and a heat transfer medium is fed into the space. The first stirrer 42 preferably has an anchor blade, and the second stirrer 45 is preferably an eccentric stirrer of a dissolver type. The dope production apparatus includes first and second feed pumps P1, P2, and valves V1-V3. However, positions and the numbers of the pumps and the valves are changed adequately.

Then the dope production method in which the dope production apparatus 10 is used will be explained below. First, the valve V1 is opened so as to feed the solvent from the first tank 11 to the third tank 16. TAC to be supplied to the hopper 15 is sent to the third tank 16 with the measurement of quantity thereof. The additives in the solution state or in the dispersion state in which they are dissolved or dispersed in the solvent are sent at necessary amount from the second tank 12 to the third tank 16 by opening the valve V2. The solvent of the additives are usually the same as that in the first tank 11. However, it may be changed in accordance with sort of additives.

If the additives are solid, a hopper and the like can be used instead of the second tank 12, so as to feed into the third tank 16. If several sorts of additives are added, a solution in which these sorts of additives are dissolved is prepared, then the solution is fed from the second tank 12 to the third tank 16, or the solutions of the additives are stored in respective plural tanks and fed to the third tank 16 through independent feed pipes. Further, if the additives are in the liquid state at the room temperature, the additives can be fed to the third tank 16 without using the solvent.

In this embodiment, the supply of the raw materials into the third tank 16 is performed in the order of the solvent, TAC and the additives, sequentially. However, the order is not restricted in this embodiment. For example, TAC, the solvent, the additives may be sequentially supplied. Note that the predetermined additives may not be mixed to TAC and the solvents at the timing of this embodiment. In consideration with sorts and properties of additives, the additives may be mixed in the following processes.

The inner temperature in the third tank 16 is controlled with use of the heat transferring medium flowing within the jacket 16a. The preferable inner temperature is in the range of −10° C. to 55° C. The solubility of cellulose acylate can be controlled depending on the types of the first and second stirrers 42,45, sort of cellulose acylate, sort of the solvent and the like. Therefore, in this embodiment, the mixture 17 is obtained as swelling solution in which TAC is swollen in the solvent. However, the present invention is not restricted in this embodiment.

Then the mixture 17 is fed to the heating device 21 with use of the pump P1. The heating device 21 is preferably a pipe with a jacket. In heating the mixture 17, the dissolution of the swollen solid material in the mixture 17 proceeds. The temperature for dissolving in the heating device 21 is preferably in the range of 0° C. to 97° C. Therefore, the heating doesn't mean the heating over the room temperature, but the increase of the temperature of the mixture 17 fed from the third tank 16. For example, when the temperature of the fed mixture 17 is −7° C., the heating also means to increase the temperature to 0° C. and so on. Further, the heating device 21 is preferably provided with a pressurizer for pressurizing the mixture 17, so as to accelerate the dissolution efficiently.

Instead of the heat-dissolution with use of the heating device 21, the mixture 17 as swelling solution may be cooled more in the range of −100° C. to −10° C. so as to perform the dissolution, which is already known as the cool-dissolution method. In this embodiment, one of the heat-dissolution and cool-dissolution methods can be chosen in accordance with the properties of the materials, so as to control the solubility.

The heated mixture 17 is fed to the temperature controlling device 23, so as to control the temperature nearly to the room temperature. Thus the polymer solution 22 in which the polymer is dissolved to the solvent can be obtained. In this embodiment, the liquid fed out from the temperature controlling device 23 is called the polymer solution 22. However, the dissolution of TAC is usually completed through the heating device 21. The polymer solution 22 is filtrated with the first filtration device 24, so as to remove undissolved or insoluble materials. The filter used in the first filtration device 24 preferably has an averaged porous diameter of at most 100 μm. The flow rate of the filtration in the first filtration device 24 is preferably at least 50 little/hr. The polymer solution 22 after the filtration is fed through the valve V3 and accumulated in the fourth tank 33.

By the way, in the above method in which the mixture 17 is prepared and then the polymer solution 22 is obtained from the mixture 17, if it is designated that the polymer solution of higher concentration is produced, the time for production becomes longer. Consequently, the production cost sometimes becomes higher. Therefore, it is preferable that the polymer solution of the lower concentration than the predetermined value is prepared at first and then the enrichment of the polymer solution is made. As such method, as shown in FIG. 1, the polymer solution 22 has the lower concentration than the predetermined value, and after the filtration thereof through the first filtration device 24, the polymer solution 22 is sent to the flushing device 27 through the valve V3. In the flushing device 27, the solvent of the polymer solution is partially evaporated. The solvent vapor generated in the evaporation is condensed by a condenser (not shown) to a liquid state, and recovered by the recovering device 31. The recovered solvent is recycled by the recirculating device 32 and reused. According to this method, the decrease of cost can be designated, since the production efficiency becomes higher and the solvent is reused.

The polymer solution 22 after the enrichment as the above description is extracted from the flushing device 27 through the pump P2. Further, in order to remove bubbles generated in the polymer solution 22, it is preferable to perform the bubble removing treatment. As a method for removing the bubble, there are many methods which are already known, for example, an ultrasonic irradiation method and the like. Then the polymer solution is fed to the second filtration device 25, in which the undissolved and insoluble materials are removed. Note that the temperature of the polymer solution 22 in the second filtration device 25 is preferably in the range of 0° C. to 200° C. Further, the polymer solution 22 is fed to the fourth tank 33 and stored.

While the polymer solution 22 is fed from the fourth tank 33 to the solution casting apparatus 40 for casting the polymer solution 22, the particles from the fifth tank 36 and the citric acid ethylester from the sixth tank 37 are added inline through the respective feed lines to the polymer solution. Note in this description that the polymer solution is called a liquid 47 after the particles are added, and the liquid 47 is called a first dope 48 after the citric acid ethylester is added. Note in this figure that the numerals of the liquid 47 and the first dope 48 and applied to arrows showing the feeding directions.

There are inline mixers 51,52 which are respectively disposed in downstream sides from the positions at which particles and the citric acid ethylester are added, and thus the mixing efficiency becomes higher. However, in the present invention, the order of the inline addition of the particles and the citric acid ethylester is may be reverse to that of this embodiment. Furthermore, in this embodiment, the dispersion or the solution of the particles and the citric acid ethylester is used for the addition, such that the adding speed may be the predetermined value. However, it is not necessary to make the addition of the dispersion or the solution.

In the present invention, since the particles and the citric acid ethylester don't directly contact each other, the aggregation of the particles is reduced. In order to keep the effect for reduction of the aggregation, it is preferable that, after one of the particles and the citric acid ethylester is added and mixed such that the concentration thereof may be uniform, the other is added. Therefore, in this embodiment, when the particles are added, the mixture thereof is made by the inline mixer, and thereafter the citric acid ethylester is added.

Instead of the inline addition, at least one tank can be used for mixing the particles or the citric acid ethylester. If a number of the tank to be used is one, they may be added in the one tank. If a number of the tank is two or more, they may be added in the respective tanks. Concretely, after the particles and the polymer solution 22 are mixed in a predetermined tank, the addition of the citric acid ethylester is made in the same tank. Otherwise, after the particles and the polymer solution are mixed in a predetermined tank, a liquid is fed to another tank, in which the addition of the citric acid ethylester is made. In consideration of these two methods, the latter method has higher production efficiencies obviously. However, in the point of the production efficiencies, namely the change for adding both materials and the continuousness of the production, the inline addition is more excellent than the addition in such one or more tanks. Especially, sort of particles or citric acid ethylester is sometimes changed in accordance with sort of dope to be produced. In the inline addition, in this case, the change of the sort can be performed without stopping the production line.

In this embodiment, both materials are added to the polymer solution 22 separately. However, the present invention is not restricted in it, and they may be added to the mixture 17 separately. Note that the addition to a liquid just before use in the solution casting apparatus as in this embodiment is especially effectively made, since the casting is performed before the occurrence of the continuous aggregation of the particles.

In the mixing of the particles and the citric acid ethylester to the polymer solution, it is preferable to use an inline mixer, such as the static mixer and the like as shown in this figure. Preferably, the static mixer has twisted blades as elements whose number is from 6 to 90, and especially from 6 to 60.

As described above, in order to produce the film having three layer structure in the solution casting apparatus 40, the dope production apparatus 10 has the feed lines L1-L3 in which the dope are prepared by different preparation methods and then fed to the solution casting apparatus 40. Further, the first dope 48 to which the particles and the citric acid ethylester are added forms a first surface layer as a contacting layer to the support in the casting process in the solution casting apparatus 40. Note that when it is designate to produce the single layer film, it is preferable to stop feeding through the second and third feed lines L2, L3 so as to use only the first feed line L1.

Also into the second feed line L2, the particles in the fifth tank 36 are added inline, and the obtained liquid is stirred by the inline mixer 53, so as to stir and disperse enough. The liquid stirred by the inline mixer 53 is fed as a second dope to the solution casting apparatus 40, without adding the citric acid ethylester. Thus the second dope forms a second surface layer in a side opposite to the casting support. Further, still another liquid is fed as a third dope to the solution casting apparatus 40 through the third feed line L3 without adding the particles. Thus the third dope forms an intermittent layer between the first and second surface layers. Note that also when it is designated to form the film having the multilayer structure having at least four layers, the dope production methods of producing the first and second dopes used for respectively forming the first and second surface layers are the same as the above description, and the number of the intermittent layers is at least 2.

In the above methods, the produced dope has the TAC concentration in the range of 5 mass % to 40 mass %. Note that the dissolution method of the materials, the raw materials, the additives in the solution casting method for forming the TAC film is described in detail from [0517] to [0616] in Japanese Patent Laid-Open Publication No.2005-104148, and the description of the publication can be applied to the present invention.

[Solution Casting Method]

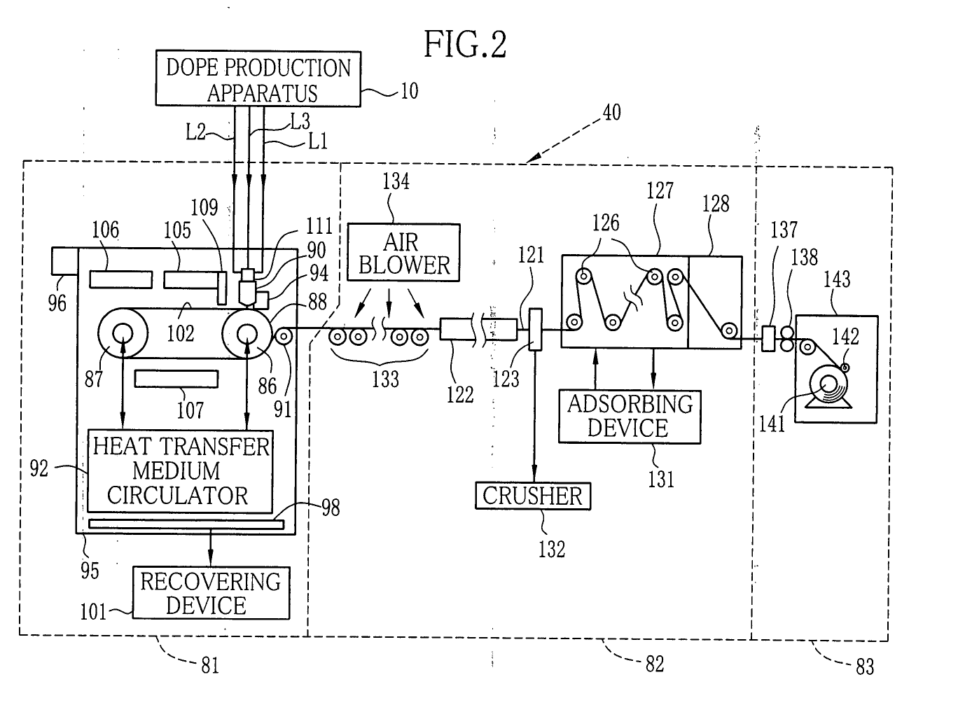

In followings, a solution casting method of manufacturing the film from the dope produced by the above dope production method will be described in reference with FIG. 2. Note that the present invention is not restricted in the solution casting apparatus of FIG. 2.

The solution casting apparatus 40 includes a casting section 81 for casting the dope, a drying section 82 for drying the film transferred from the casting section 81, and a winding section 83 for winding the dried film. However, these sections are not clearly partitioned in this apparatus.

At first, the explanation of the casting section 81 will be made. The casting section 81 includes a belt as a support 88 continuously running in accordance with the rotation of back-up rollers 86, 87, a casting die 90 for casting the dope onto the support 88, and a peel roller 91 for peeling the cast dope as the film. To the back-up rollers 86, 87 is attached a circulating device 92 for circulating a heat transferring medium, and surfaces of the back-up rollers 86, 87 are controlled by the circulating device 92. Further, there is a decompression chamber 94 for decompressing a space in a back side of a bead of the three dopes that is formed between the casting die 90 and the support 88.

The above instruments for the casting, such as the casting die 90 and the support 88, are contained in a casting chamber 95, in which there is a temperature controlling device 96 for controlling an inner temperature and a condenser 98 for condensing a vapor of the organic solvent. In an outside of the casting chamber 95, there is a recovering device 101 for recovering the condensed organic solvent.

Further, in the casting chamber 95, there are air blowers 105, 106, 107 for feeding air blows onto a casting film 102. In this embodiment, the position for attachment of each air blower 105, 106, 107 is in an upper and upstream side, an upper and downstream side, and a lower side of the support. However, the present invention is not restricted in it. Further, an air shielding device 109 is disposed close to the support 88 in the downstream side from the casting die 90.

Herein, each instrument for the casing included in the casting section 81 will be explained. As shown in FIGS. 2&3, there is a feed block 110 to which the dope is supplied. The preferable material of the casting die 90 is stainless steel of double phase type, having a complex composition of an austenitic phase and a ferrite phase, and the coefficient of thermal expansion is preferably at most 2×10⁻⁵ (° C.⁻¹). Further, there is a material having anti-corrosion properties, which is almost the same as SUS316, in the examination of forcible corrosion in the electrolyte solution. Such material can be used. Preferably, the materials to be used for the casting die 90 has the anti-corrosion properties, such that the pitting doesn't occur on the gas-liquid interfere even if the material is dipped in a mixture of dichloromethane, methanol and water for three months. The casting die 90 is preferably manufactured by performing the polishing after a month from the casting of the material. Thus the surface condition of the dope flowing in the casting die 90 is kept uniform. The finish precision of a contact face of the casting die to a feed block (explained later) is at most 1 μm in surface roughness and at most 1 μm/m in straightness. The clearance of a slit of the casting die 90 is automatically adjustable in the range of 0.5 mm to 3.5 mm. According to an edge of the contact portion of a lip end of the casting die 90, R (R is a chamfered radius) is at most 50 μm in all of a width. Further, the shearing speed in the casting die is controlled in the range of 1 to 5000 per second.

It is preferable to attach a temperature controller (not shown) to the casting die 90, such that the temperature may be kept to the predetermined one during the film production. Further, the casting die 90 is preferably a coat hanger type die. The thickness of the casting film is often controlled by adjusting a feed rate of the feed pump from the casting die 90. Further, in order to adjust a thickness profile in a widthwise direction of the casting film, the casting die 90 is preferably provided with an automatic thickness adjusting device. For example, it is preferable that thickness adjusting bolts (heat bolts) for controlling a lip clearance are disposed as the automatic thickness adjusting instrument at a predetermined interval in a widthwise direction of the casting die 90. Note that the film thickness is defined in consideration with a change of the thickness and the smoothness in the widthwise direction. Further, according to the heat bolts, it is preferable that the profile is set on the basis of a predetermined program, depending on feed rate of a pump (preferably, a high accuracy gear pump) 43. Further, the feed back control of the adjustment value of the heat bolts may be made by the adjusting program on the base of the profile of a thickness gauge (not shown), such as infrared ray thickness gauge and the like. The thickness difference between any two points in the widthwise direction except the side edge portions in the casing film is controlled preferably to at most 3 μm, and especially to at most 1 μm. Further, the accuracy to the designated object value of the thickness is preferably in ±1.5 μm.

Preferably, a hardened layer is preferably formed on a top of the lip end. A method of forming the hardened layer is not restricted. But it is, for example, ceramics hard coating, hard chrome plating, neutralization processing, and the like. If ceramics is used as the hardened layer, it is preferable that the used ceramics is grindable but not friable, with a lower porosity. Further preferably, the ceramics have low wetting property. Concretely, there are tungsten carbide (WC), Al₂O₃, TiN, Cr₂O₃, and the like. Especially preferable ceramics is tungsten carbide. Tungsten carbide coating can be made by an spraying method.

Further, in order to prevent the partial dry-solidifying of a dope on a slit end of the casting die 90, it is preferable to provide a solvent supplying device (not shown) at the slit end, on which a gas-liquid interfaces are formed between both edges of the slit and both bead edges and the outer gas. Preferably, these gas-liquid interfaces are supplied with the solvent which can dissolve the dope, (for example a mixture solvent of dichloromethane 86.5 pts.mass, acetone 13 pts.mass, n-butanol 0.5 pts.mass). The solvent is preferably supplied to each edges of the bead from 0.05 mL/min to 1.0 mL/min. Thus the solidifications at both bead edges and the mixing of the solid into the casting film are prevented. Note that the pump for supplying the solvent has a pulse rate at most 5%.

The width and the length of the support 88 are not restricted especially. However, preferably, when the belt is used as teh support 88 in this embodiment, the belt is from 30 m to 200 m in length and 0.5 mm to 5 mm in thickness, and the thickness unevenness is at most 0.5%. The surface is preferably polished so as to have a surface roughness at most 0.05 μm. The support 88 is preferably made of stainless, and especially of SUS 316 so as to have enough resistance of corrosion and strength.

Note that it is possible to use a drum as the support. In this case, the drum is preferably a roller which can rotate at high accuracy such that the rotation unevenness caused by the eccentricity of rotary shaft may be at most 0.2 mm, and the surface roughness is preferably at most 0.01 μm. Further, the chrome plating is preferably performed to the drum such that the drum may have enough hardness and endurance. As described above, it is necessary in the support that the surface defect must be reduced to be minimal. Concretely there are no pin hole of at least 30 μm, at most one pin hole in the range of 10 μm to 30 μm, and at most two pin holes of less than 10 μm per 1 m².

Then the drying section 82 will be explained in the followings. The drying section 82 includes a tenter 122, an edge slitting device 123 disposed in a downstream from the tenter 122, a drying device 127 and a cooling device 128. The tenter 122 dries a film 121 which has been obtained by peeling from the support 88, and stretches the film 121 in a predetermined direction. The edge slitting device 123 slits both side edge portions of the film 121. In the drying device 127, the film 121 whose side edge portions are slit off is dried with transfer of plural rollers 126, and then in the cooling device 128, the film 121 is cooled. The drying device 127 has an adsorbing device 131 for adsorbing and recovering the solvent vapor. Note that the edge slitting device 123 is connected to a crusher 132 for crushing dusts of the slit side edge portions of the film 121. Further, there is an air blower 136 in an interval section 133, before the enter of the film 121 into the tenter 122.

The winding section 83 has a compulsory neutralization device (or a neutralization bar) 137 for controlling a charged electrostatic potential of the film 121 to a predetermined value, a knurling roller 138 for performing an embossing treatment to both side portions of the film 121, and a winding shaft 141 for winding the film 121. The winding roller 141 includes a press roller 142 for controlling the film tension at the winding. Note that the winding roller 141 and the press roller 142 are included in a winding chamber 143.

Then the film manufacturing method with use of the solution casting apparatus 40 will be described below. The back-up rollers 86, 87 below the casting die 90 are rotated by the driving device (not shown), and thus the support 88 runs endlessly in accordance with the rotation of the back-up rollers 86, 87. Then the casting speed is preferably in the range of 10 m/min to 200 m/min. The drive of the back-up rollers 86, 87 is preferably controlled such that the tension generated in the support 88 may be 1.5×10⁴ kg/m, and therefore the difference of the relative speed between the support 88 and each back-up roller 86, 87 is controlled to be at most 0.01 m/min. According to the control of the support 88, preferably, the change of the running speed is at most 0.5% from the predetermined value, and the meandering in the widthwise direction in one cycle running is at most 1.5 mm. In order to reduce the meandering, a detector (not shown) is preferably provided above each edge portion of the support 88, so as to make a feed-back control of the disposition angle of rotary shaft of each back-up roller on the basis of measured values. Furthermore, the position of the support 88 shifts up- and downwardly in accordance with the rotation of the back-up roller 86. Therefore, it is preferable that the position of the support 88 is preferably controlled just below the casting die 90, such that a shift range of the support 88 may be at most 200 μm.

Further, in this embodiment, the temperatures of the back-up rollers 86, 87 are controlled by a medium circulating device 92 for cycling a heat transfer medium. It is preferable that the surface temperature of the support 88 is adjusted in the range of −20° C. to 40° C. by heat transmission from the back-up rollers 86, 87. In this embodiment, passages (not shown) of the heat transfer mediums are formed in the back-up rollers 86, 87, and the heat transfer mediums whose temperatures are controlled by the medium circulating device pass through the passages. Thus the-temperature of the back-up rollers 86, 87 are kept to the predetermined values.

In the present invention, the first—third dopes 48, 111, 112 produced as described above are cast so as to respectively form a first surface layer contacting to the support 88, a second surface layer positioned oppositely to the support 88, and an intermittent layer between the first and second surface layers. Preferably, the temperatures of the first—third dopes 48, 111, 112 are in the range of −10° C. to 57° C. Note that in the production of a single layer film, only the first dope 48 is fed to the casting die 90 in a similar manner as above, and cast onto the support 88.

In the back side of the bead formed between the casting die 90 and the support 88, there is a decompression chamber 94 for controlling the pressure in the back side. Thus the formation of the bead is stabilized, and the wobbling of the bead is reduced. The decompression degree (difference from the atmospheric pressure) is preferably in the range of −100 Pa to −100 Pa. An inner temperature of the decompression chamber 94 is not restricted especially, but preferably in the range of 30° C. to 50° C. For controlling the inner temperature, it is preferable to provide the decompression chamber 94 with a jacket. Further, aspirators may be provided with the casting die 90, so as to be near both side edges of an outlet of the dope. Thus the aspiration in both side edges of the bead is made to stabilize the shape of the bead. In this case, the force velocity of the aspiration is preferably in the range of one to one hundred Litter/min.

The organic solvent evaporated from a casting film 97 on the support 88 is condensed by the condenser 98. The condensed organic solvent is recovered by the recovering device 101 and used as the solvent for preparing the dope.

Further, the drying airs from the air blowers 105, 106, 107 accelerate the evaporation of the solvent in the casting layer 102. Further, although the drying airs cause to change surface conditions of the casting film 102 just after the formation, the air shielding device 109 reduces the change of the surface conditions. The inner temperature of the casting chamber 95 is preferably controlled in the range of −10° C. to 57° C. by the temperature controller 96.

If necessary, a drying air at a predetermined temperature is applied by the air feeder 134 to accelerate the dry of the film 121 with the transportation to the tenter 122. The temperature of the drying air from the air feeder 134 is in the range of 20° C. to 250° C. In the interval section 133, the rotation speed of the one roller is higher than the neighboring roller in the upstream side. Thus the tension can be applied to the film 121 in the transporting direction.

Here, a measuring method of the peeling force at peeling the casting film 102 from the support (or the adhesive force between the support and the casting film) is explained. The dope is cast on a metal which is the same as the material of the support, and peeled. At this moment, a force of peeling is measured. In this embodiment, the time period from the casting to the peeling is varied, and the force is measured as often as the time period varies. The largest one of the measured value is determined as the peeling force (or the adhesive force). Note that the present invention doesn't depend on the measurement method of the peeling force, and other method may be applied to the present invention. In this case, it is necessary to know the relativity of the obtained data in the other method to the measured data in the above measuring method, and the peeling force is preferably controlled to the preferable value for the present invention, namely at most 60×9.8 (mN) on the basis of the relativity and the obtained data.

In the tenter 122, both side edge portions of the film 121 are held by holding members, such as clips and the like, and the film 121 is dried with the transportation. The tenter 122 of this embodiment stretches the film 121 in the widthwise direction. Thus, it is preferable in the interval section 133 and the tenter 122 that the film 121 is stretched to become larger by 0.5% to 300% in at least one of the transporting direction (or acasting direction) and the widthwise direction. Preferably, the tenter is partitioned, such that the drying condition (temperatures and the like) may be adjusted adequately in each partition.

The film 121 is dried until the content of the remaining solvent become the predetermined value, and then both side edge portions are slit off by the edge slitting device 123. The slit side edge portions are sent to the crusher 132 by a cutter blower (not shown), and crushed to tips by the crusher 132. The tips are reused for preparing the dope, which is effective in view of the decrease of the production cost. Note that the slitting process of both side edge portions may be omitted. However, it is preferable to perform the slitting between the casting process and the winding process in the winding section 83.

The film 121 whose side edge portions are slit off is sent to the drying device 127 and dried furthermore. In the drying device 127, the film 121 is transported with lapping partially around the rollers 126. The inner temperature of the drying device 127 is not restricted especially. However, it is preferable in the range of 40° C. to 160° C. The solvent vapor evaporated from the film 121 by the drying device 127 is adsorbed by the adsorbing device 131. The air from which the solvent components are removed is reused for the drying air in the drying device 127. Note that the drying device 127 preferably has plural partitions for variation of the drying temperature. Further, a pre-drying device (not shown) is provided between the edge slitting device 123 and the drying device 127, so as to perform the pre-drying of the film 121. Thus it is prevented that the temperature of the film 121 increases rapidly, and therefore the change of the shape of the film 121 is reduced.

In the cooling device 128, the film 121 is cooled to around the room temperature. A humidity control chamber (not shown) may be provided for conditioning the humidity between the drying device 127 and the cooling device 128. Preferably, in the humidity control chamber, an air whose temperature and humidity are controlled is applied to the film 121. Thus the curling of the film 121 and the winding defect in the winding process can be reduced.

Thereafter, the compulsory neutralization device (or a neutralization bar) 137 eliminates the charged electrostatic potential of the film 121 to the predetermined value (for example, in the range of −3 kV to +3 kV). The position of the neutralization process is not restricted in this embodiment. For example, the position may be a predetermined position in the drying section or in the downstream side from the knurling roller 138, and otherwise, the neutralization may be made at plural positions. After the neutralization, the embossing of both side portions of the film 81 is made by the embossing rollers to provide the knurling. The emboss height from the bottom to the top of the embossment is in the range of one micrometer to two hundred micrometers.

In the last process, the film 121 is wound by the winding roller 141. At this moment, a tension is applied at the predetermined value by the press roller 142. Preferably, the tension is gradually changed from the start to the end of the winding. In the present invention, the film 121 is at least 100 m in length, and at least 600 mm in width. In the present invention, when the width is from 1400 mm to 1800 mm, the effect becomes especially large. However, even if the width more than 1800 mm, the present invention is effective. Further, the present invention may be also applied when it is designated to produce a thin film which is from 15 μm to 100 μm in thickness.

In the solution casting method of the present invention, there are casting methods for casting plural dopes, for example, a co-casting method and a sequential casting method. In the co-casting method, a feed block may be attached to the casting die as in this embodiment, or a multi-manifold type casting die (not shown) may be used. In the film of multi-layer structure, at least one of the thickness of the peeled layer from the support and that of the opposite layer thereto is preferably in the range of 0.5% to 30% of the total film thickness. Furthermore, when it is designated to perform the co-casting, a dope of higher viscosity is sandwiched by lower-viscosity dopes. Concretely, it is preferable that the dopes for forming the surface layers have higher viscosity than the sandwiched dope for forming a intermittent layer between the surface layers.

Japanese Patent Application No.2003-319673 describes from [0610] to [0842] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

[Properties & Measuring Method]

(Degree of Curl & Thickness)

Japanese Patent Laid-Open Publication No.2005-104148 describes from [0112] to [0139] about the properties of the wound cellulose acylate film and the measuring method thereof. The properties and the measuring methods can be applied to the present invention.

[Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

[Functional Layer]

(Antistatic, Hardened, Antireflection, Easily Adhesive & Antiglare Layers)

The cellulose acylate film may be provided with an undercoating layer on at least one of the surfaces, and used in the several ways.

It is preferable to use the cellulose acylate film as a base film to which at least one of functional layers may be provided. The preferable functional layers are an antistatic layer, a cured resin layer, an antireflection layer, an easily adhesive layer, an antiglare layer and an optical compensation layer.

These functional layers preferably contain at least one sort of the surfactants in the range of 0.1 mg/m² to 1000 mg/m². Further, the functional layers preferably contain at least one sort of the lubricants in the range of 0.1 mg/m² to 1000 mg/m². Furthermore, the functional layers preferably contain at least one sort of the matting agent in the range of 0.1 mg/m² to 1000 mg/m². Furthermore, the functional layers preferably contain at least one sort of the antistatic agent in the range of 1 mg/m to 1000 mg/m². Conditions and Methods for forming the functional layer are described in detail from [0890] to [1087] of Japanese Patent Laid-Open Publication No.2005-104148, which can be applied to the present invention. Thus the produced film can have several functions and properties.

(Variety of Use)

The produced cellulose acylate film can be effectively used as a protection film for a polarizing filter, and an optical compensation film. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Application No.2003-319673 discloses the liquid crystal displays of TN type, STN type, VA type, OCB type, reflective type, and other types in detail. Further, in the description of this application, a cellulose acylate film is provided with an optically anisotropic layer, and another cellulose acylate film is provided with antireflective and-antiglare functions. Further, the publication describes about the optically biaxial cellulose acylate film provided with adequate optical properties. This cellulose acylate film may be used with the protective film for the polarizing filter. These descriptions of the publication No.2005-104148 continues from [1088] to [1265] which can be applied to the present invention.

Various changes and modifications are possible in the present invention and may be understood to be within the present invention.

What is claimed is:

1. A method of producing a cellulose acylate film, comprising:
casting a solution containing cellulose acylate, a solvent, and polycarboxylic acid derivative onto a running support, a weight of polycarboxylic acid being at most a weight of said carboxylic acid derivative when said polycarboxylic acid derivative contains said polycarboxylic acid;
peeling said cast solution as a film; and
drying said film.

2. A method as described in claim 1, wherein said polycarboxylic acid derivative and said polycarboxylic acid are a peeling force controller such that said peeling force may be at most 60×9.8 (mN) per 1 cm in width of said film at peeling said film from said support.

3. A method as described in claim 1, wherein said polycarboxylic acid derivative is polycarboxylic acid ester.

4. A method as described in claim 3, wherein following conditions are satisfied:
ya≦Y/2; and
0.5≦(Y−ya)/(X+Y)≦1.0;
wherein X is weight of said polycarboxylic acid, Y is weight of said polycarboxylic acid ester, and ya is weight of entire esterified compound contained in said polycarboxylic acid ester.

5. A method described in claim 3, wherein said polycarboxylic acid ester is citric acid alkyl ester.

6. A method described in claim 5, wherein a following condition is satisfied:
0.25≦y2/y1≦4;
wherein y1 is weight of monoester and y2 is weight of diester.

7. A method described in claim 5, wherein said citric acid alkylester are at least one of citric acid methylester and citric acid ethylester.

8. A cellulose acylate film containing cellulose acylate and polycarboxylic acid derivative, in which a weight of polycarboxylic acid is at most that of said polycarboxylic acid derivative.

9. A cellulose acylate film as described in claim 8, wherein said polycarboxylic acid derivative is polycarboxylic acid ester.

10. A cellulose acylate film as described in claim 9, wherein following conditions are satisfied:
ya≦Y/2; and
0.5≦(Y−ya)/(X+Y)≦1.0;
wherein X is weight of said polycarboxylic acid, Y is weight of said polycarboxylic acid ester, and ya is weight of entire esterified compound contained in said polycarboxylic acid ester.

11. A cellulose acylate film described in claim 10, wherein said polycarboxylic acid ester is citric acid alkyl ester.

12. A cellulose acylate film described in claim 11, wherein a following condition is satisfied:
0.25≦y2/y1≦4;
wherein y1 is weight of monoester and y2 is weight of diester.

13. A cellulose acylate film described in claim 11, wherein said citric acid alkylester are at least one of citric acid methylester and citric acid ethylester.
